(19) United States
(12) Patent Application Publication
(10) Pub. No.: US 2014/0103785 A1
(43) Pub. Date: Apr. 17, 2014

(54) CONCEALED WALL COMPARTMENT

(71) Applicant: Jason Eric Richards, Ogden, UT (US)

(72) Inventor: Jason Eric Richards, Ogden, UT (US)

(21) Appl. No.: 13/652,475

(22) Filed: Oct. 16, 2012

(51) Int. Cl. A47B 81/00; E05G 1/024

(52) U.S. Cl. CPC A47B 81/005; E05G 1/024
USPC 312/204

(57) ABSTRACT

A concealed compartment is disclosed for safekeeping valuables and small objects, including firearms. The concealed safe is suitable for insertion into a wall between studs or into a ceiling between supports. The concealed safe comprises a hollow storage compartment defined by internal walls. The storage compartment is concealed by a planar or irregularly-shaped ornamental effect, such as a mirror, picture, light or painting, overlaying the outwardly facing access opening of the storage compartment. The ornamental effect is configured to slide up, down or laterally when moved to reveal the storage compartment and its contents. Various embodiments of the present invention include a second storage compartment disposed behind the storage compartment, as well as magnets for suspending valuables and locking mechanisms.

### BACKGROUND OF THE INVENTION

1. Field of the Invention

This invention relates to storage compartments, and more particularly relates to concealed storage compartments.

2. Description of the Related Art

The prior art teaches wall safes which are designed to be recessed into the interior of a building wall. These safes typically comprise doors which swing outward on hinges and are accessible only with combination or key locking mechanisms. The contents of these swinging safes can be difficult to access quickly in exigent situations, such as a burglary, and are used principally to store and conceal valuables such as jewelry. There exist no means in the art of rapidly accessing hidden effects such as pistols or personal firearms for home defense.

Further disadvantages of these previously known wall safes include difficulty opening either a key or combination lock with one hand. It is desirable that a concealed storage compartment be accessible with a single hand while another hand is otherwise engaged in repelling an intruder.

Consequently, the wall safes known in the art cannot be rapidly accessed or, if the key or combination are inaccessible, the safe cannot be opened at all. There exists a need in the industry for a rapidly accessible wall safe easily concealed behind an ornamental design. The present invention discloses such a device as further described below.

### SUMMARY OF THE INVENTION

From the foregoing discussion, it should be apparent that a need exists for an easily accessible concealed wall compartment. The present invention has been developed in response to the present state of the art; and, in particular, in response to the problems and needs in the art that have not yet been fully solved by currently available methods, systems and apparatus, and that overcome many or all of the above-discussed shortcomings in the art. Accordingly, the present invention has been developed to provide a concealed wall compartment for recessing between studs of an interior wall, the wall compartment comprising: a substantially planar ornamental effect having a planar rear surface; an interior storage compartment having a plurality of interior walls defining a storage cavity, the storage cavity accessible via a forward opening concealed by the ornamental effect; one or more bearings slides permanently affixed to the storage compartment and detachably affixed to the rear surface of the ornamental effect, such that the ornamental effect may replaced with a substitute ornamental effect; wherein the ornamental effect is slideable laterally to reveal the opening behind the ornamental effect.

The ornamental effect may comprise one of a mirror, painting, photograph, picture, decorative air vent, light fixture, flat screen display, illustration, and sheet of transparent materials for viewing the contents of the storage compartment. In other embodiments, the concealed wall compartment further comprises a second storage compartment disposed behind the storage compartment.

In some embodiments, one or more of the interior walls conceal an opening to the second storage compartment, the one or more interior walls slideable to reveal the opening to the second storage compartment. In still further embodiments, one or more magnets are affixed to one or more of the interior walls.

The one or more magnets may serve to magnetically grip a firearm.

The concealed wall compartment may further comprise locking means for locking the ornamental effect in place over the opening such that the ornamental effect is immobile until the locking mechanism is released.

A second concealed wall compartment for recessing between supports of an interior ceiling, the wall compartment is disclosed comprising: a substantially planar ornamental effect having a planar rear surface; an interior storage compartment having a plurality of interior walls defining a storage cavity, the storage cavity accessible from a forward opening concealed by the ornamental effect; one or more bearing slides permanently affixed to the storage compartment and detachably affixed to the rear surface of the ornamental effect, such that the ornamental effect may replaced with a substitute ornamental effect; wherein the ornamental effect is slideable laterally to reveal the opening behind the ornamental effect.

The concealed wall compartment may further comprise one or more magnets affixed to one or more of the interior walls. The one or more magnets may serve to magnetically grip a firearm.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a lower perspective view of a concealed wall compartment in accordance with the present invention;

FIG. 1B is an upper perspective cross-sectioned environmental view of a concealed wall compartment in accordance with the present invention;

FIG. 2 is a lower perspective view of a concealed wall compartment in accordance with the present invention;

FIG. 3 is an upper perspective environmental view of a concealed wall compartment in accordance with the present invention; and

FIG. 4 is a lower perspective environmental view of a concealed ceiling compartment in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

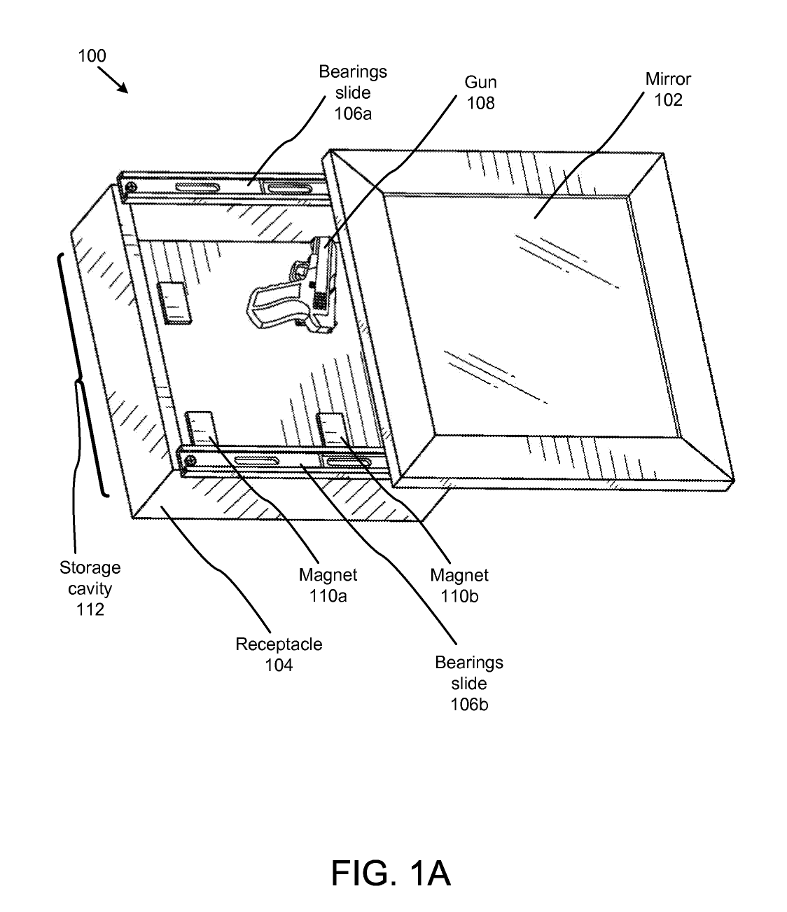

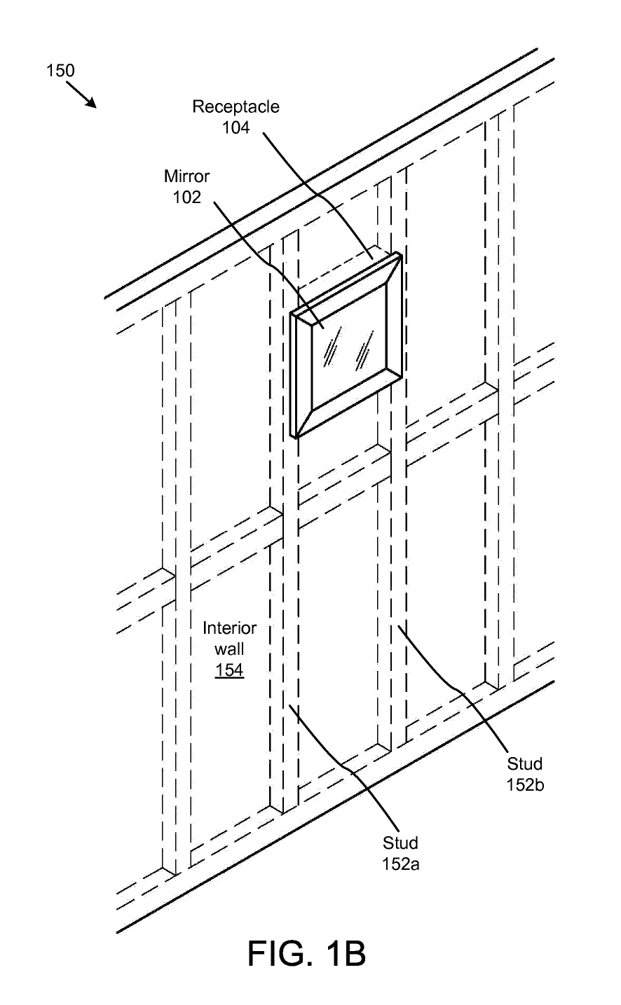

FIG. 1A is a lower perspective view of a concealed wall safe 100 in accordance with the present invention. The wall safe 100 comprises a mirror 102, a receptacle/storage compartment 104, a bearings slide 106a, a bearings slide 106b, a gun 108, a magnet 110a, and a magnet 110b. The receptacle 104 defines a storage cavity 112.

The mirror 102 is well-known to those of skill in the art. The mirror 102 is an ornamental effect and is detachable to the bearing slide 106a. The mirror 102 may be replaced with a picture, photograph, poster, painting, decorative air vent, light fixture, or any other piece of decor. In some embodiments, a clear sheet of glass or plexiglass replaces the mirror 102 such that the contents of the storage compartment 104 are plainly visible to those staring inside.

In the shown embodiment, the mirror 102 is detachable affixed to two linear-motion bearings slides 106a-b. In other embodiments, the mirror 102 may be affixed to other types of tracks as known to those of skill in the art, such as wood slides. The linear motion bearings slides 106a-b comprise, in the shown embodiment, ball-bearing drawer slides common in the art.

The bearings slides may be affixed to the outer edge of the receptacle 104 using means known to those of skill in the art, including bolts, nails, adhesives, and the like. In some embodiments the opening is partially covered by a planar top surface, or partial wall.

In the shown embodiments, the storage compartment 104 comprises five interior walls. The storage compartment 104 defines a storage cavity 112 for storing personal effects or valuables, such as jewelry, cash, documents, or guns 108.

The interior walls may be fabricated from wood, metal, metal alloys, silicone, fiberglass, polymeric materials, or like. The storage compartment 104, in some embodiments, may be fabricated as a single integrated piece.

The shown storage compartment 104 is designed to a width dimension matching the width between studs in an interior residential wall. In some embodiments, the storage compartment 104 is elongated to store more cumbersome personal effects, such as rifles.

The magnets 110a-d may be affixed to the interior walls of the storage compartment 104 to magnetically grip personal effects, such as jewelry or guns 108.

FIG. 1B is an upper perspective cross-sectioned environmental view of a concealed wall safe 150 in accordance with the present invention.

The receptacle 104 is affixed between studs 152a-b of an interior wall 154.

In typical embodiments, drywall, plaster, tile, or the like is bored out to create a recess in the interior wall 154 the size of the receptacle 104. The receptacle 104 is recessed into the recess such that the edges of the mirror 102 rest on the drywall or outer surface of the interior wall 154 surrounding the receptacle 104.

In typical embodiments, the mirror 104 has a perimeter which in magnitude exceeds the perimeter of the receptacle 104 such that the mirror 104 juts out beyond the borders of the receptacle 104 and conceals the bored recess into the interior wall 154.

In some embodiments, the receptacle 104 comprises two ornamental effects disposed on opposing sides of the receptacle 104. In those embodiments, the receptacle traverses an interior wall 154 entirely such that the receptacle 104 is accessible via opposing ornamental effects 102 on either side of the wall. In those embodiments, the receptacle 104 comprises four interior walls rather than five, as the fifth interior wall is now replaced by the second, and opposing, ornamental effect.

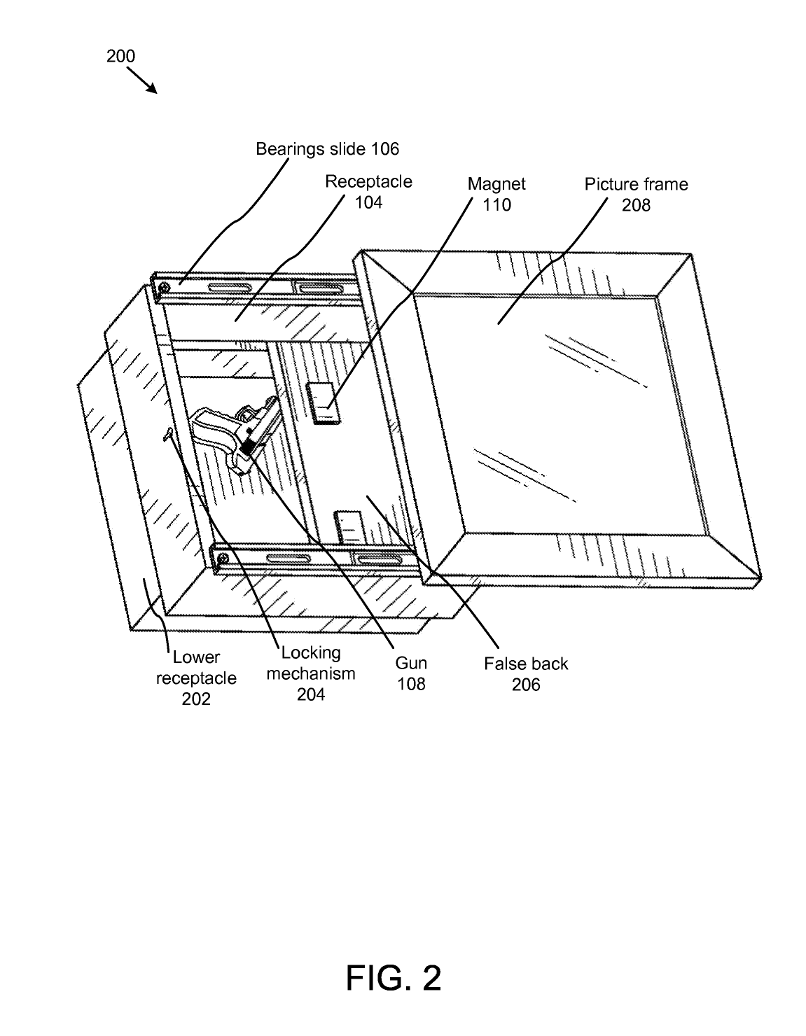

FIG. 2 is a lower perspective view of a concealed wall safe 200 in accordance with the present invention. The wall safe 100 comprises a mirror 102, a receptacle/storage compartment 104, a bearing slide 106a, a gun 108, a magnet 110, a lower receptacle 202 a locking mechanism 204, a false back 206, and a picture frame 208. The receptacle 104 defines a storage cavity 112.

In some embodiments, the concealed wall safe 200 comprises a lower receptacle 202 disposed behind the receptacle 104. The lower receptacle 202 is concealed by one of the interior walls which doubles as a false back 206.

The false back 206 slides laterally, or up or down, to reveal the opening to the lower receptacle 202. In some embodiments, the false back 206 is hingedly connected to the receptacle 104 such that the false back swings outward to open and reveal the lower receptacle 202.

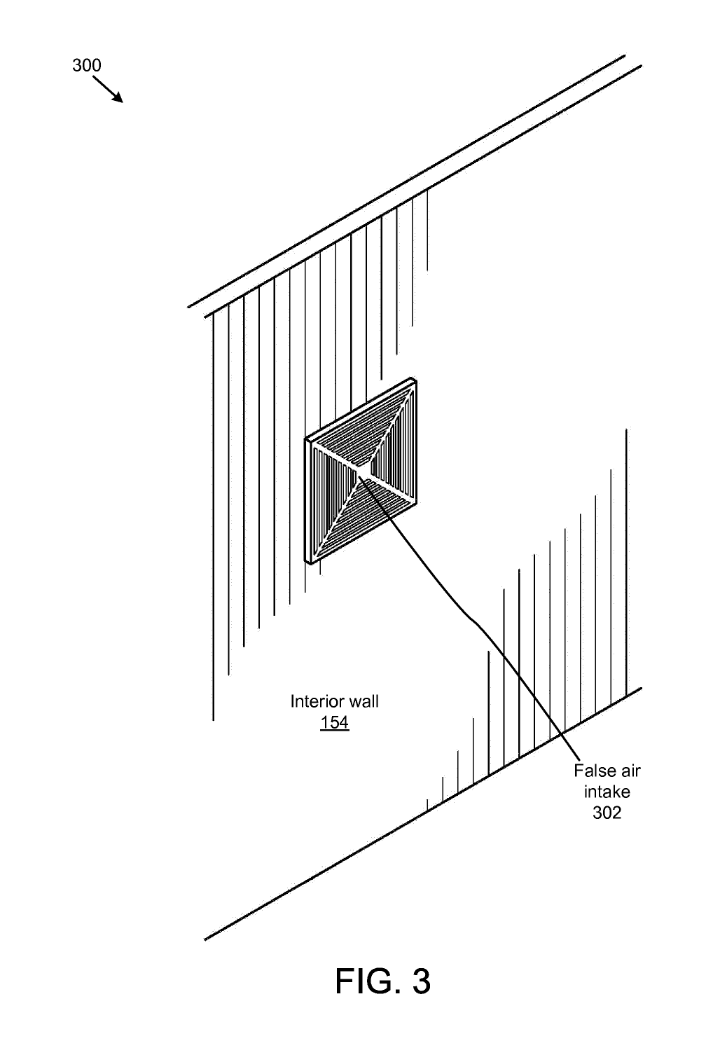

FIG. 3 is an upper perspective environmental view of a concealed wall safe 300 in accordance with the present invention.

As shown, in some embodiments, the ornamental effect comprises a decorative air intake 302. The ornamental effect may also comprises, in other embodiments, a photograph, painting, illustration, stuffed game animal head, or any other hanging ornamental effect.

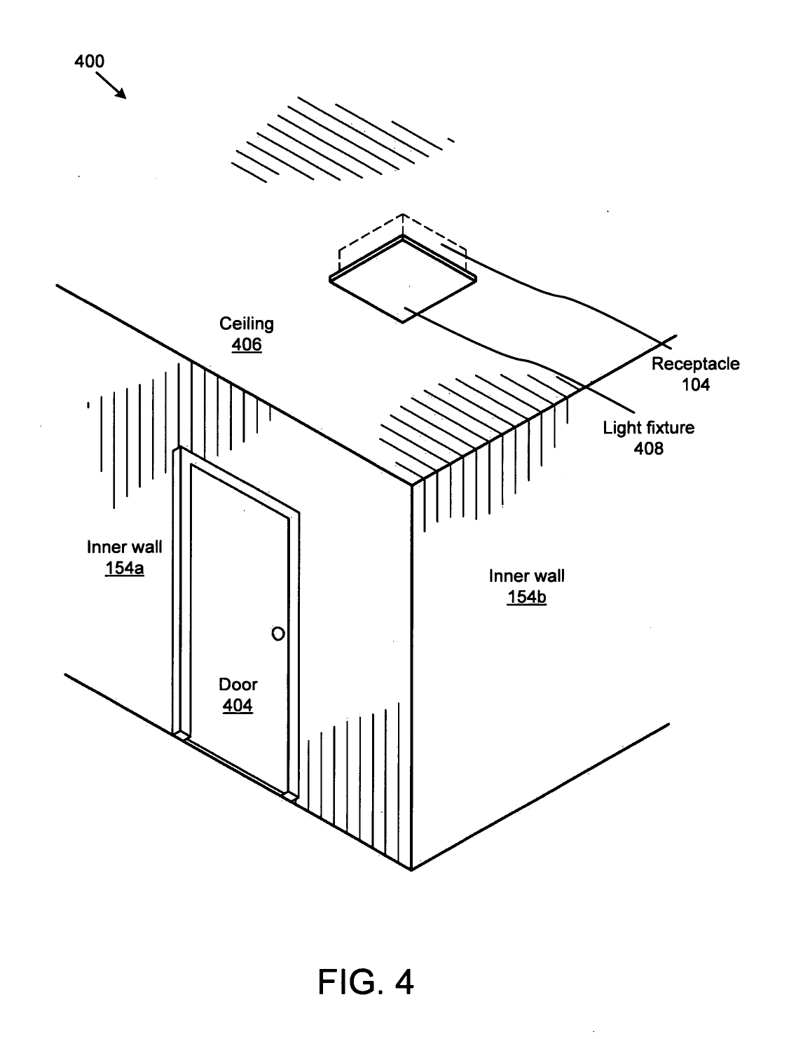

FIG. 4 is a lower perspective environmental view of a concealed ceiling compartment 400 in accordance with the present invention.

In some embodiments, the ornamental effect comprises a false or real light fixture 408. In these embodiments, the magnets 110 hold in place the personal effects in the storage compartment 104 when the ornamental effect is slid open laterally.

In other embodiments, the concealed ceiling compartment 400 comprises two light fixtures or ornamental effects, both of which provide access to the receptacle 104. In those embodiments, the second ornamental effect is accessible via a floor or roof overlaying the receptacle 104.

The functions of the systems shown in the present invention correspond generally to other systems, methods, apparatii and computer program products outlined in the present invention, and further illustrates the availability of different allocations of functionality amongst modules that implement an embodiment of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A concealed wall compartment for recessing between studs of an interior wall, the wall compartment comprising:
a substantially planar ornamental effect having a planar rear surface, the planar rear surface oriented vertically in parallel with a wall surface;
an interior storage compartment having a plurality of interior walls defining a storage cavity, the storage cavity accessible via a forward opening concealed by the ornamental effect, wherein the storage compartment is designed to a width dimension matching a width between studs in an interior residential wall; and
one or more bearings slides permanently affixed to the storage compartment and detachably affixed to the rear surface of the ornamental effect, such that the ornamental effect may replaced with a substitute ornamental effect;
wherein the ornamental effect is slideable laterally to reveal the opening behind the ornamental effect.

2. The concealed wall compartment of claim 1, wherein the ornamental effect comprises one of a mirror, painting, photograph, picture, decorative air vent, light fixture, flat screen display, and an illustration.

3. The concealed wall compartment of claim 1, further comprising a second storage compartment disposed behind the storage compartment.

4. The concealed wall compartment of claim 3, wherein one or more of the interior walls conceal an opening to the second storage compartment.

5. The concealed wall compartment of claim 4, wherein the rearward opening is concealed by a second ornamental effect, wherein the interior storage compartment is affixed within a wall of a residence between two exposed wall surfaces.

6. The concealed wall compartment of claim 1, wherein the one or more interior walls are slideable to reveal the opening to the second storage compartment.

7. The concealed wall compartment of claim 1, further comprising one or more magnets affixed to one or more of the interior walls.

8. The concealed wall compartment of claim 5, wherein the one or more magnets magnetically serve to magnetically grip a firearm.

9. The concealed wall compartment of claim 1, further comprising locking means for locking the ornamental effect in place over the opening such that the ornamental effect is immobile until the locking mechanism is released.

10. A concealed wall compartment for recessing between supports of an interior ceiling, the ceiling wall compartment comprising:
a substantially planar ornamental effect having a planar rear surface;
an interior storage compartment having four interior walls affixed to the rear surface, the interior walls defining a storage cavity, the storage cavity accessible from one or more of a forward opening concealed by the ornamental effect; and
one or more bearing slides permanently affixed to the storage compartment and detachably affixed to the rear surface of the ornamental effect, such that the ornamental effect may replaced with a substitute ornamental effect;
wherein the ornamental effect is slideable laterally to reveal the opening behind the ornamental effect.

11. The concealed wall compartment of claim 10, further comprising one or more magnets affixed to one or more of the interior walls.

12. The concealed wall compartment of claim 11, wherein the one or more magnets magnetically serve to magnetically grip a firearm.

13. The concealed wall compartment of claim 11, wherein the ornamental effect consists of a light fixture.

14. A concealed wall compartment for recessing between studs of an interior wall, the wall compartment comprising:
a substantially planar ornamental effect having a planar rear surface;
a first interior storage compartment having a plurality of interior walls defining a storage cavity, the storage cavity accessible via a forward opening concealed by the ornamental effect, wherein the storage compartment is designed to a width dimension matching the width between studs in an interior residential wall;
one or more bearings slides permanently around an opening to the storage compartment and detachably affixed to the rear surface of the ornamental effect, such that the ornamental effect may replaced with a substitute ornamental effect; wherein the ornamental effect is slideable laterally to reveal the opening behind the ornamental effect; and
a false back slidably affixed to the first storage compartment;
a second interior storage compartment having a plurality of interior walls defining a second storage cavity, the storage cavity accessible via the false back when slid aside; and
a magnet affixed to one of the interior walls of the second storage compartment, the magnet for detachably holding a gun.

15. The concealed wall compartment of claim 14, further comprising a plurality of magnets affixed to the false back.
